(19) United States
(12) Patent Application Publication
(10) Pub. No.: US 2007/0152905 A1
(43) Pub. Date: Jul. 5, 2007

(54) Intelligent antenna

(75) Inventor: Ming-Hao Yeh, Hsinchu (TW)

Correspondence Address: BACON & THOMAS, PLLC, 625 SLATERS LANE, FOURTH FLOOR, ALEXANDRIA, VA, 22314, US

(73) Assignee: Alpha Networks Inc., Hsinchu (TW)

(21) Appl. No.: 11/320,660

(22) Filed: Dec. 30, 2005

(51) Int. Cl. H01Q 3/24

(52) U.S. Cl. 343/876; 343/853

(57) ABSTRACT

The present invention is to provide an intelligent antenna mounted on a circuit board including an antenna diversity transceiver circuit connected to an intermediate third end of a T-shaped connecting member, and a first and a second antenna units connected to two symmetric ends of the T-shaped connecting member respectively, wherein two radio frequency switches are interconnected the second antenna unit and one of the two symmetric ends through two transmission lines respectively. Thus, an antenna diversity signal sent from the antenna diversity transceiver circuit is adapted to switch both the radio frequency switches so as to direct signal from the second antenna unit to the T-shaped connecting member through the two transmission lines, which are adapted to generate a phase difference either in-phase or out-of-phase between signals sent from the first and second antenna units, in order to obtain an optimum signal receiving quality for the intelligent antenna and eliminate dead angle problem caused by antenna radiation field.

### FIELD OF THE INVENTION

The present invention relates to antenna structure and more particularly to an intelligent antenna having a T-shaped connecting member to connect a first and a second antenna units and form an antenna array, wherein two radio frequency switches are interconnected the second antenna unit and one of two symmetric ends of T-shaped connecting member through two transmission lines respectively, enabling the first and second antenna units to be utilized to obtain an optimum signal receiving quality for the intelligent antenna.

### BACKGROUND OF THE INVENTION

Currently, a wireless transceiver is required to have multiple antenna for preventing dead angles from occurring in sending and receiving the electromagnetic waves as stipulated in WLAN (wireless local area network) standard. Hopefully, received signal quality can be optimum.

There is a trend of downsizing wireless transceivers in the manufacturing of the art. However, area for mounting antenna on the circuit board of a wireless transceiver becomes even smaller. The antenna area is further limited since there are many components and mechanisms are mounted in the circuit board of the wireless transceiver. As a result, antenna elements are located even closer. Antenna diversity is thus introduced in arranging antenna elements. However, signal receiving quality has not improved significantly.

Referring to FIG. 1, it schematically shows a conventional antenna diversity arrangement mounted on a circuit board of the wireless transceiver and it explains the reason of being incapable of obtaining an optimum signal receiving quality by the well-known antenna diversity arrangement. On the circuit board there are provided two spaced antenna units 1 each connected to either one of two first ports 20 at one end of a high frequency switch 2. The high frequency switch 2 has its other end provided with a second port 22 which is connected to a antenna diversity transceiver circuit 3 on the circuit board. The antenna diversity transceiver circuit 3 is adapted to compare quality of signal sent from one antenna unit 1 with that of signal sent from the other antenna unit 1. Further, the antenna diversity transceiver circuit 3 is adapted to switch the high frequency switch 2 to connect to the antenna unit 1 having a better signal receiving quality. Hence, the antenna may send and receive the electromagnetic waves through the selected one antenna unit 1 rather than the other one. In other words, only one antenna unit 1 is utilized at one time even there are two antenna units 1 provided on the circuit board. Quality of signal received by one antenna unit 1 is substantially the same as that received by the other antenna unit 1 since they are located in close proximity. Hence, little improvement with respect to signal quality is achieved while the antenna diversity transceiver circuit 3 is mounted. Thus, it is desirable to provide a novel antenna capable of fully utilizing two antenna units and thus significantly improving signal receiving quality in order to overcome the inadequacy of the prior art.

### SUMMARY OF THE INVENTION

After considerable research and experimentation, an intelligent antenna according to the present invention has been devised so as to overcome the above drawback of the prior art.

It is an object of the present invention to provide an intelligent antenna mounted on a circuit board including an antenna diversity transceiver circuit. The antenna diversity transceiver circuit is connected to an intermediate third end of a T-shaped connecting member. Two symmetric ends of the T-shaped connecting member are connected to first and second antenna units respectively. Thus a two-element antenna array consisting of the antenna units and the T-shaped connecting member is formed. The third end of the T-shaped connecting member as a feeding end is interconnected the two-element antenna array and the antenna diversity transceiver circuit on the circuit board. Two radio frequency switches are interconnected the second antenna unit and the second end of the T-shaped connecting member. Two transmission lines are interconnected the radio frequency switches. An antenna diversity signal sent from the antenna diversity transceiver circuit is adapted to switch both the radio frequency switches so as to direct signal from the second antenna unit to the T-shaped connecting member through either the first transmission line or the second transmission line. The second transmission line is adapted to generate a phase difference between signal sent from the first antenna unit and that sent from the second antenna unit. That is, the signal sent from the first antenna unit may be either in-phase or out-of-phase with that sent from the second antenna unit in order to obtain an optimum signal receiving quality for the intelligent antenna. By utilizing this intelligent antenna, it is possible of eliminating dead angle problem caused by antenna radiation field. Further, both the antenna units are utilized, thereby eliminating the drawback of utilizing only one antenna unit at one time as implemented in the prior antenna diversity technique.

The above and other objects, features and advantages of the present invention will become apparent from the following detailed description taken with the accompanying drawings.

### BRIEF DESCRIPTION OF THE DRAWINGS

FIG. 1 schematically depicts a conventional antenna diversity arrangement mounted on a circuit board of a wireless transceiver;

FIG. 2 schematically depicts a circuit board having an antenna diversity arrangement according to a preferred embodiment of the invention;

FIG. 3 schematically depicts a signal strength of distant radiation generated by two in-phase signals fed from two antenna units of the invention;

FIG. 4 schematically depicts a signal strength of distant radiation generated by two out-of-phase signals fed from two antenna units of the invention;

FIG. 5 is a graph showing measured signal strength of distant radiation when signals fed from two antenna units of the invention are in-phase; and

FIG. 6 is a graph showing measured signal strength of distant radiation when signals fed from two antenna units of the invention are out-of-phase.

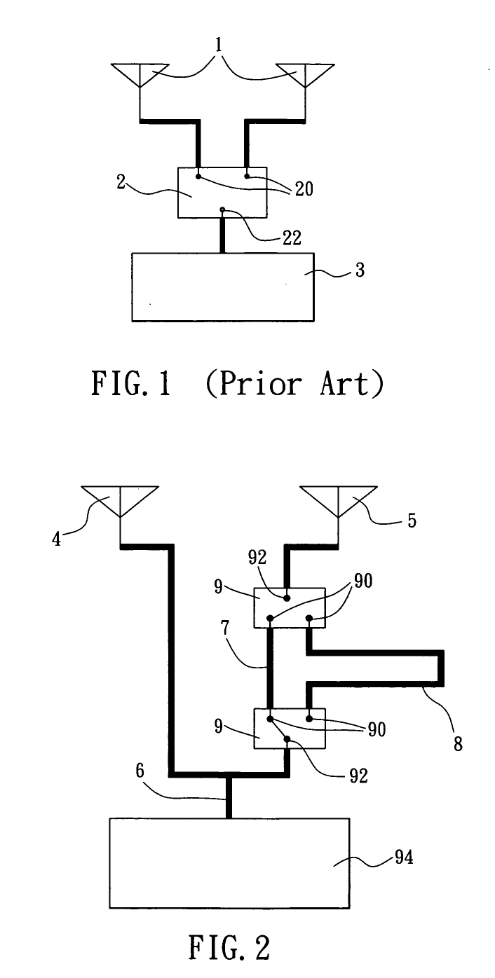

### DETAILED DESCRIPTION OF THE PREFERRED EMBODIMENTS

Referring to FIG. 2, an intelligent antenna in accordance with a preferred embodiment of the invention is mounted on a circuit board of a device. The antenna comprises a first antenna unit 4, a second antenna unit 5, a T-shaped connecting member 6, a first transmission line 7, a second transmission line 8, and two radio frequency switches 9. Each component is discussed in detailed below. The first antenna unit 4 is connected to a first end of the T-shaped connecting member 6 and the second antenna unit 5 is connected to a second end of the T-shaped connecting member 6 in which the first and second ends of the T-shaped connecting member 6 are symmetric about a third end thereof. Thus, a two-element antenna array consisting of the antenna units 4 and 5 and the T-shaped connecting member 6 is formed. The third end of the T-shaped connecting member 6 is a joining end of the two-element antenna array and an antenna diversity transceiver circuit 94 provided on the circuit board. Signal may be fed to the antenna units 4 and 5 through the joining end (i.e., the third end of the T-shaped connecting member 6). The radio frequency switches 9 are interconnected the second antenna unit 5 and the second end of the T-shaped connecting member 6. The transmission lines 7 and 8 are interconnected the radio frequency switches 9. An antenna diversity signal sent from the antenna diversity transceiver circuit 94 is adapted to switch both the radio frequency switches 9 so as to direct signal from the second antenna unit 5 to the T-shaped connecting member 6 through either the first transmission line 7 or the second transmission line 8. Further, the second transmission line 8 is adapted to generate a phase difference between signal sent from the first antenna unit 4 and that sent from the second antenna unit 5. That is, signal sent from the first antenna unit 4 may be either in-phase or out-of-phase with that sent from the second antenna unit 5 in order to obtain an optimum signal receiving quality, thereby eliminating dead angle problem caused by antenna radiation field. In other words, switching the radio frequency switches 9 by the antenna diversity signal is similar to select a best receiving quality from signals received from different directions. Also, both the antenna units 4 and 5 are utilized. Thus, it eliminates the drawback of utilizing only one antenna unit at one time as implemented in the prior antenna diversity technique.

Referring to FIG. 2 again, in the invention two first ports 90 are provided on one end of one radio frequency switch 9 and two first ports 90 are provided on the other opposite end of the other radio frequency switch 9. Also, a second port 92 is provided on the other end of one radio frequency switch 9 and a second port 92 is provided on one end of the other radio frequency switch 9. The first transmission line 7 is interconnected one first port 90 of one radio frequency switch 9 and one first port 90 of the other radio frequency switch 9. The second transmission line 8 is interconnected the other first port 90 of one radio frequency switch 9 and the other first port 90 of the other radio frequency switch 9. The second port 92 of one radio frequency switch 9 is connected to the second end of the T-shaped connecting member 6 and the second port 92 of the other radio frequency switch 9 is connected to the second antenna unit 5. Both the radio frequency switches 9 are switched synchronously in order to connect the second antenna unit 5 and the T-shaped connecting member 6 together through either the first transmission line 7 or the second transmission line 8.

In the invention, each of the first transmission line 7 and the second transmission line 8 has a length and a shape equal to λ2. Thus, there is a phase difference of 180 degrees between the transmission lines 7 and 8. That is, signal sent from the first antenna unit 4 may be either in-phase or out-of-phase with that sent from the second antenna unit 5. Following is a detailed description about distant radiation difference caused by signal sent from the first antenna unit 4 being either in-phase or out-of-phase with that sent from the second antenna unit 5.

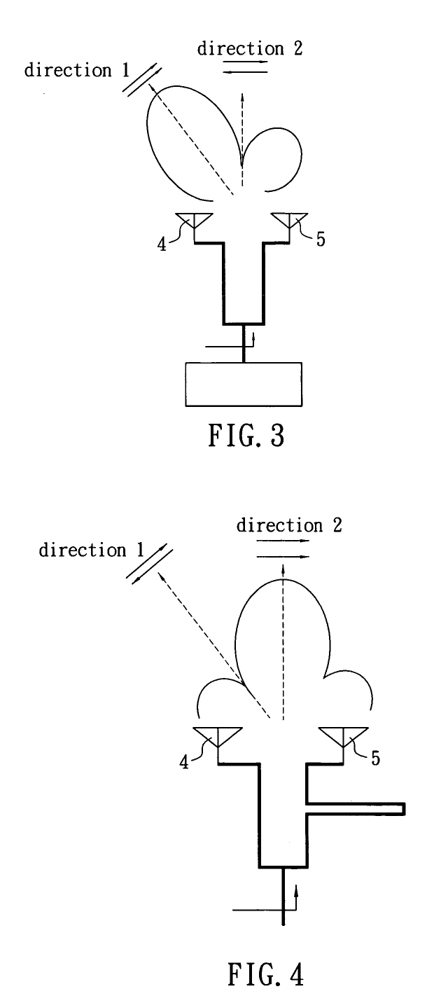

Referring to FIG. 3, it is assumed that a distant radiation is generated by signals sent from the in-phase transmission lines 4 and 5. In direction 1, it is assumed that electromagnetic field strength is a maximum for each of the transmission lines 4 and 5, polarization of the first transmission line 4 is the same as that of the second transmission line 5, and phase of the first transmission line 4 is the same as that of the second transmission line 5. Thus, signal strength in the direction 1 is a maximum due to positive addition of phases. Likewise, electromagnetic field strength is a maximum for each of the transmission lines 4 and 5, polarization of the first transmission line 4 is the same as that of the second transmission line 5, but phase of the first transmission line 4 is opposite to that of the second transmission line 5 (i.e., there is a phase difference of 180 degrees). Thus, signal strength in the direction 2 is a minimum due to negative addition of phases. As to directions other than above, electromagnetic field strength is a value between maximum and minimum for each of the transmission lines 4 and 5, polarization of the first transmission line 4 is the same as that of the second transmission line 5, but phase of the first transmission line 4 is not the same as that of the second transmission line 5 (i.e., there is a phase difference between 0 degree and 360 degrees but other than 180 degrees). Thus, signal strength in any direction other than directions 1 and 2 is neither maximum nor minimum due to neither positive nor negative addition of phases.

Referring to FIG. 4, it is assumed that a distant radiation is generated by signals sent from the in-phase transmission lines 4 and 5. In direction 1, it is assumed that electromagnetic field strength is a maximum for each of the transmission lines 4 and 5, polarization of the first transmission line 4 is the same as that of the second transmission line 5, and phase of the first transmission line 4 is opposite to that of the second transmission line 5 (i.e., there is a phase difference of 180 degrees). Thus, signal strength in the direction 1 is a minimum due to negative addition of phases. Likewise, electromagnetic field strength is a maximum for each of the transmission lines 4 and 5, polarization of the first transmission line 4 is the same as that of the second transmission line 5, but phase of the first transmission line 4 is the same as that of the second transmission line 5. Thus, signal strength in the direction 2 is a maximum due to positive addition of phases. As to directions other than above, electromagnetic field strength is a value between maximum and minimum for each of the transmission lines 4 and 5, polarization of the first transmission line 4 is the same as that of the second transmission line 5, but phase of the first transmission line 4 is not the same as that of the second transmission line 5 (i.e., there is a phase difference between 0 degree and 360 degrees but other than 180 degrees). Thus, signal strength in any direction other than directions 1 and 2 is neither maximum nor minimum due to neither positive nor negative addition of phases.

In view of above, switching the radio frequency switches 9 by the antenna diversity signal is similar to select a best receiving quality from signals received from different directions. Also, it is similar to a simple 2×2 fixed beam-forming system mentioned in the intelligent antenna. Thus, signal receiving strength from each of many different directions is considered by the intelligent antenna of the invention so as to automatically adjust its antenna units to receive signal in a preferred direction, thereby eliminating dead angle problem caused by antenna radiation field.

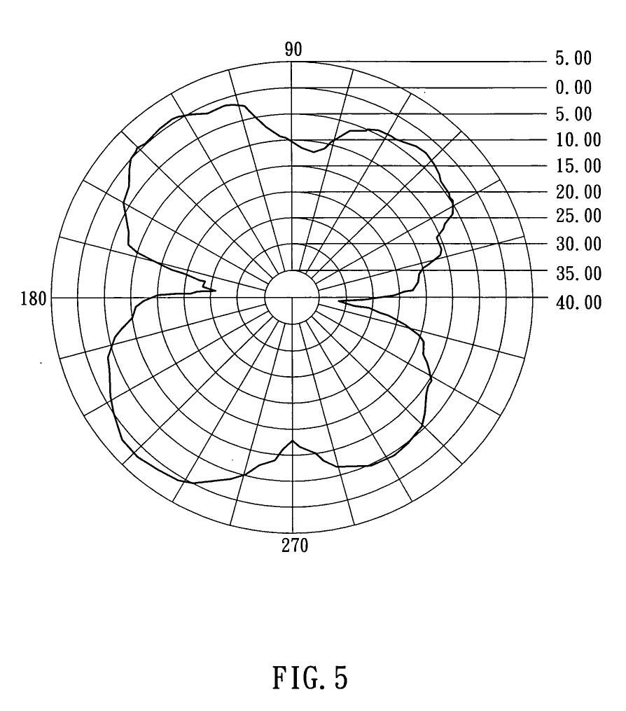

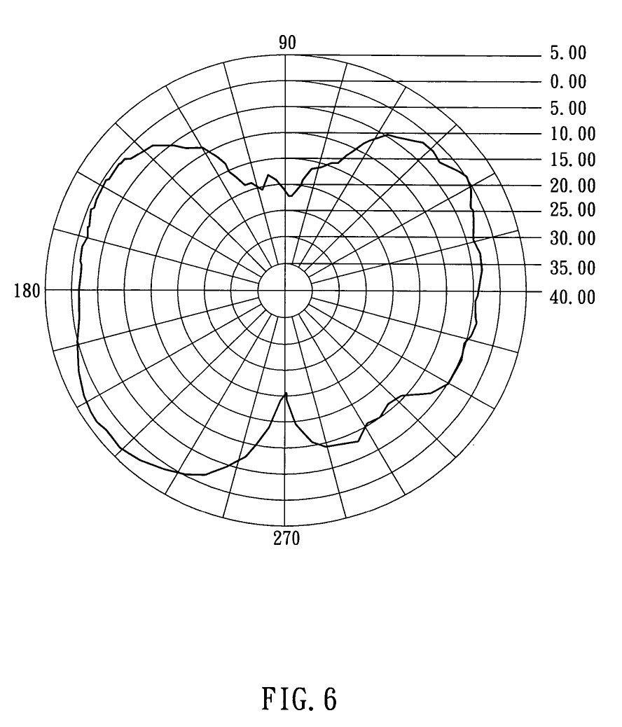

Moreover, the intelligent antenna is configured as a two-element antenna array in its operating state. Thus, antenna gain is increased significantly. Referring to FIG. 5, it is a graph showing measured signal strength of distant radiation when signals fed from the antenna units 4 and 5 are in-phase. Referring to FIG. 6, it is a graph showing measured signal strength of distant radiation when signals fed from the antenna units 4 and 5 are out-of-phase.

While the invention herein disclosed has been described by means of specific embodiments, numerous modifications and variations could be made thereto by those skilled in the art without departing from the scope and spirit of the invention set forth in the claims.

What is claimed is:

1. An intelligent antenna mounted on a circuit board, comprising:
a first antenna unit;
a second antenna unit;
a T-shaped connecting member including a first end connected to the first antenna unit, a second end connected to the second antenna unit and a third end, wherein the first and the second ends of the T-shaped connecting member are symmetric about the third end thereof, and the antenna units and the T-shaped connecting member form a two-element antenna array with the third end as a feeding point of the antenna array;
a first transmission line;
a second transmission line; and
a first radio frequency switch and a second radio frequency switch both interconnected the second antenna unit and the second end of the T-shaped connecting member;
wherein the transmission lines are interconnected the radio frequency switches, both the radio frequency switches are adapted to switch for directing a signal from the second antenna unit to the T-shaped connecting member through either the first transmission line or the second transmission line, and the second transmission line is adapted to generate phase difference between the signal sent from the first antenna unit and that sent from the second antenna unit.

2. The intelligent antenna of claim 1, wherein the first radio frequency switch includes two first ports provided on the other end and a second port provided on one end; the second radio frequency switch includes two first ports provided on one end and a second port provided on the other end; and wherein the first transmission line is interconnected one first port of the first radio frequency switch and one first port of the second radio frequency switch, the second transmission line is interconnected the other first port of the first radio frequency switch and the other first port of the second radio frequency switch, the second port of the second radio frequency switch is connected to the second end of the T-shaped connecting member, and the second port of the first radio frequency switch is connected to the second antenna unit.

3. The intelligent antenna of claim 1, wherein both the radio frequency switches are switched synchronously for connecting the second antenna unit and the T-shaped connecting member together through either the first transmission line or the second transmission line.

4. The intelligent antenna of claim 2, wherein both the radio frequency switches are switched synchronously for connecting the second antenna unit and the T-shaped connecting member together through either the first transmission line or the second transmission line.

5. The intelligent antenna of claim 3, wherein each of the first transmission line and the second transmission line has a length and a shape equal to λ2.

6. The intelligent antenna of claim 4, wherein each of the first transmission line and the second transmission line has a length and a shape equal to λ2.
